(19) United States
(12) Patent Application Publication
(10) Pub. No.: US 2013/0272042 A1
(43) Pub. Date: Oct. 17, 2013

(54) CONTROL TECHNIQUE FOR A THREE-PHASE BOOST CONVERTER TO ACHIEVE RESISTIVE INPUT BEHAVIOR

(71) Applicants: Mehrdad Moallem, Surrey (CA); Reza Sabzehgar, New Westminster (CA)

(72) Inventors: Mehrdad Moallem, Surrey (CA); Reza Sabzehgar, New Westminster (CA)

(73) Assignee: Simon Fraser University, Burnaby (CA)

(21) Appl. No.: 13/786,153

(22) Filed: Mar. 5, 2013

Related U.S. Application Data
(60) Provisional application No. 61/607,373, filed on Mar. 6, 2012.

(51) Int. Cl. H02M 7/217

(52) U.S. Cl. CPC H02M 7/217
USPC 363/89

(57) ABSTRACT

A three-phase boost converter is disclosed, as well as a related control technique. In certain embodiments, the provided boost converter enables efficient transfer of energy from an irregular input power source to a battery storage device or a DC link. To achieve maximum power absorption in such cases, the provided embodiments utilize a variable resistive behavior across each phase of the converter using feedback control.

### CROSS-REFERENCE TO RELATED APPLICATION

This application claims the benefit of U.S. Provisional Patent Application No. 61/607,373, filed Mar. 6, 2012, the disclosure of which is incorporated herein by reference in its entirety.

### BACKGROUND

Three phase power electronic converters are required in renewable generation systems such as variable speed wind and marine wave energy. In these renewable energy systems, the kinetic energy of the device is converted into stand-alone or grid-connected electricity through three phase synchronous or induction generators and power electronics interfaces. The intermittent characteristic of the above energy resources results in generated power profiles with time-varying voltages and currents whose amplitudes and frequencies are subject to random variations. Dynamically stable and efficient energy flow in these systems require the use of advanced power controllers that can adapt to the dynamic characteristics of the source and load. Traditional AC-DC converters using diodes and thyristors to provide energy flow have issues including poor power quality, voltage distortion, and poor power factor.

High power factor three-phase rectifiers and control techniques have been studied.

Among the proposed topologies, three-phase boost/buck converters are good candidates to be utilized in energy conversion involving random sources of power as they can offer high efficiency and low electromagnetic interference emissions. Performance criteria of these converters is highly dependent on the control strategy used. To improve the performance of pulse-width-modulated (PWM) boost/buck converters toward ideal power quality conditions, different control strategies have been presented using space vector modulation, soft switching, sliding mode, and other feedback control methods.

Previous devices have primarily been utilized in applications such as speed drives and power supplies for telecommunications equipment in which the mains supply is the input power source with a relatively fixed amplitude and frequency. These approaches have mainly assumed the circuits to be in the sinusoidal steady state, which cannot be applied to applications involving random sources of power with transient power profiles such as wind, wave, and mechanical vibrations. Furthermore, to achieve maximum power transfer in renewable energy converters including wind and wave, it is sometimes necessary to control the amount of generator loading, which can be achieved through appropriate control of the power electronics interface. For example, in variable speed wind energy conversion systems, there is an optimum torque-speed characteristic that would yield maximum power transfer to the electrical generator.

In certain studies, a condition for maximum extraction of the average power is obtained for a wave energy converter, which suggests operation under the resonance condition with a resistive behavior seen by the generator. An effective way of achieving the above conditions for maximum power transfer is to adjust the apparent electric load of the generator through an appropriate controller using a power electronics interface. However, the extension of previous methods for the above renewable energy applications is not straightforward and further development of devices and methods are desirable.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an illustration of a three-phase bridge-less boost-type rectifier in accordance with the disclosed embodiments;

FIGS. 2A-2C are illustrations of operation modes of a three-phase boost rectifier in accordance with the disclosed embodiments: FIG. 2A: Mode 1 of circuit operation when Q₁, Q₂ , and Q₃ are all ON; FIG. 2B: Mode 2 of circuit operation when Q₁ and Q₂ are OFF and Q₃ is ON; FIG. 2C: Mode 3 of circuit operation when Q₁ and Q₂ are OFF, Q₃ is ON, and the inductor current of phase b reaches zero (i_{Lb}=0);

FIG. 3 is an illustration of currents in the inductors in a discontinuous conduction mode of a three-phase boost rectifier in accordance with the disclosed embodiments;

FIG. 4 is a block diagram of a feedback control scheme for a three-phase boost rectifier in accordance with the disclosed embodiments;

FIG. 5 is an illustration of theoretical and simulated values of relative resistance seen from the input voltage sources of phase b and c (R_{bc}) of a three-phase boost rectifier in accordance with the disclosed embodiments; and

FIGS. 6A and 6B are simulated waveforms for sine wave input sources (Vₐ, V_{b}, V_{c}) for a three-phase boost rectifier in accordance with the disclosed embodiments: FIG. 6A: Input voltages and input currents multiplied by the value of desired resistance (R_{d}=200Ω) of three phases; FIG. 6A: Duty cycle of pulse width modulated (PWM) signal of FIG. 6A.

### DETAILED DESCRIPTION

In the provided embodiments, a new modeling and control technique for a three-phase boost converter is disclosed. In certain embodiments, the provided boost converter enables efficient transfer of energy from an irregular input power source to a battery storage device or a DC link. To achieve maximum power absorption in such cases, the provided embodiments utilize a resistive behavior across each phase of the converter (e.g., a boost-type circuit) using feedback control. The converter does not require a priori knowledge of the input waveform characteristics, such as frequency or amplitude. Furthermore, it can convert band-limited waveforms with multiple input frequencies and amplitudes by exhibiting desired input resistances at the three-phase source input based on desired set-points that can be varied during operation.

In one aspect, a method for converting an irregular power signal into an optimal DC power signal is provided. In one embodiment, the method includes the steps of:

(a) providing a three-phase boost converter circuit comprising:
(i) an input;
(ii) an output;
(iii) a pulse-width modulated (PWM) switching circuit in communication with the input and the output; and
(iv) a feedback controller configured to change a resistance of the PWM switching circuit across each phase of the PWM switching circuit in real time;

(b) providing an irregular power signal to the input of the three-phase boost converter circuit; and

(c) adjusting the resistance applied to each phase of the three-phase boost converter circuit using the feedback controller to provide an optimal DC power signal to a load in communication with the output.

In one embodiment, the irregular power signal does not have at least one of the following: a sinusoidal steady state, a fixed amplitude, or a fixed frequency.

In one embodiment, the feedback controller is configured to control an ON/OFF state of individual switches in the PWM switching circuit to achieve a desired resistance in the PWM switching circuit.

In one embodiment, the PWM switching circuit comprises three switches configured to switch between ON and OFF states, and wherein during at least one step of the method a first switch is allowed to switch between ON and OFF states, and a second switch and a third switch are not allowed to switch between ON and OFF states, thereby increasing power efficiency by reducing switching power loss.

In one embodiment, the feedback controller is configured to control a duty cycle of the PWM switching circuit.

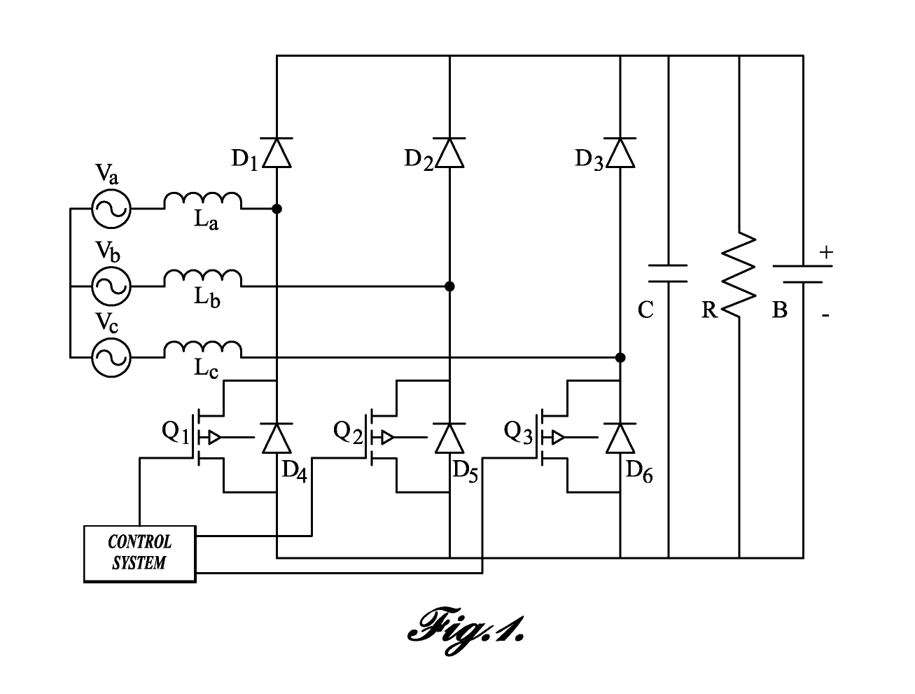

In another aspect, a three-phase boost converter as described herein is provided (e.g., as illustrated in FIG. 1 and described in the related FIGURES).

The aspects and embodiments of the disclosure will now be described in further detail.

The following disclosure is divided into multiple sections, as follows. First, a novel network model of a three-phase boost converter is developed using the method of averaging followed by a derivation of the conditions under which the pulse width modulated (PWM) switching circuit exhibits resistive behavior from the input. Based on the model obtained, a feedback controller is developed to regulate the three-phase input resistances of the circuit to the desired values. The circuit can be designed to provide purely active power conversion of a band-limited input voltage source to a DC load. Numerical simulations are presented that illustrate performance of the provided modeling and feedback control scheme. Representative applications are related to a small scale wave energy converter and a regenerative mechanism to convert vibration energy in vehicular suspension into battery charge.

The results indicate that unity power factor operation for irregular and time-varying inputs is achievable through a feedback controller with the capability to change resistive input behavior based on desired set-points. The converter can thus be used in various applications requiring real-time change of desired input resistance to control and optimize the energy flow to a DC link (e.g., in order to generate energy from renewable energy sources).

### Operating Principle and Circuit Analysis

The three-phase bridge-less boost converter of the provided embodiments is illustrated in FIG. 1. Compared to a conventional boost rectifier, one diode is eliminated from the line-current path, resulting in reduced conduction losses. Also, Schottky diodes and MOSFETs are used to achieve low conduction losses. Furthermore, to reduce switching losses, only one MOSFET is allowed to switch at each time instant, while the other two are kept on/off, depending on the relative voltages of the corresponding phases.

It should be pointed out that while a specific circuit (i.e., that of FIG. 1) is presented and described herein, the control and switching algorithm provided can be implemented in any suitable form, for example, using low-cost embedded computing devices such such as microcontrollers and FGPAs. Accordingly, the disclosure herein should be interpreted broadly as describing representative embodiments.

In the following, a brief review of the circuit operation is provided, followed by a derivation of the nonlinear resistances seen by the input sources vₐ, v_{b}, and v_{c} using an averaging method.

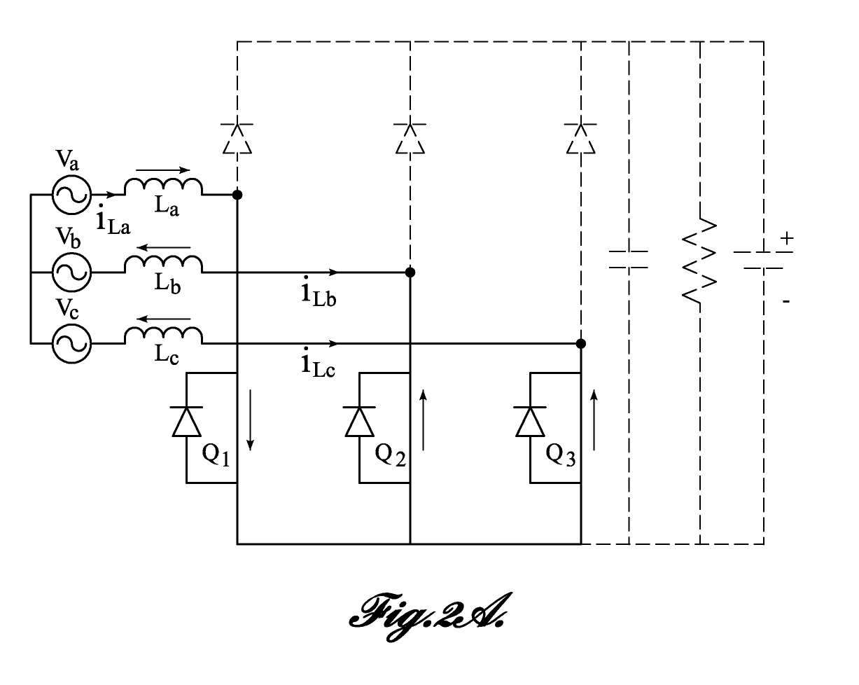

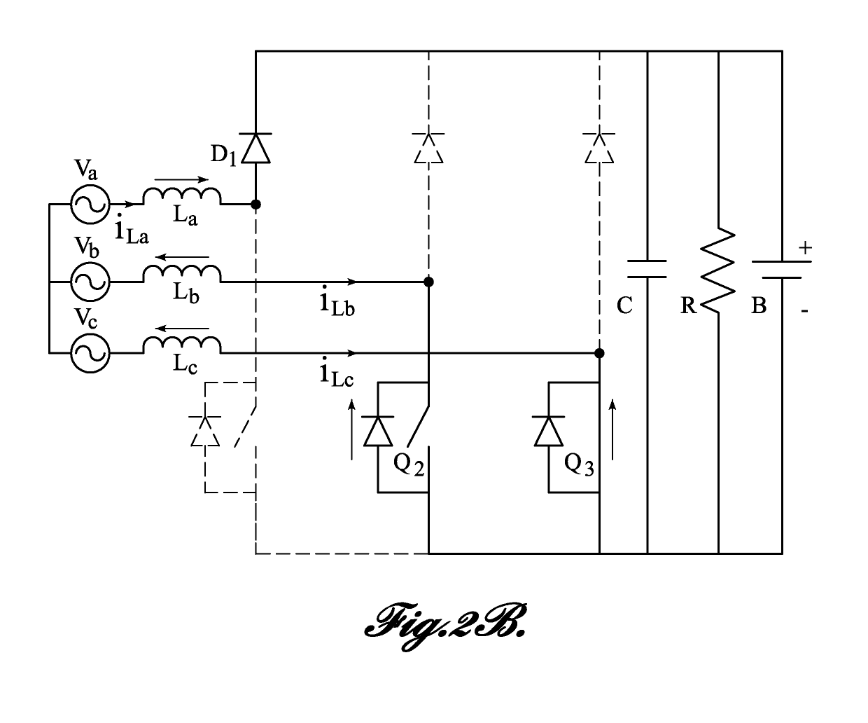

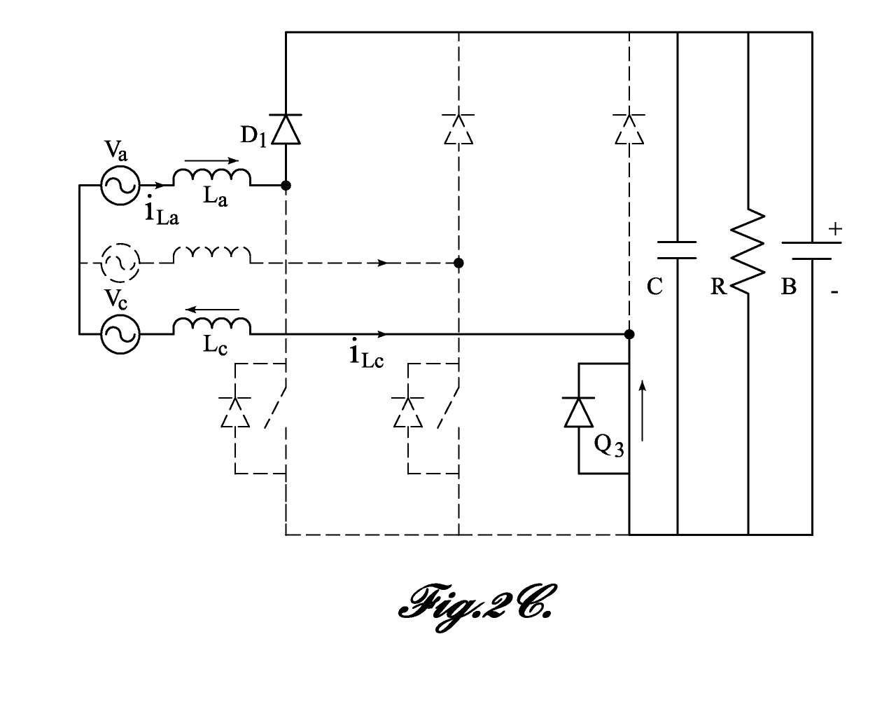

FIGS. 2A-2C illustrate snapshots for various modes of operation of the circuit involving switches Q₁ diodes D₁, and the corresponding phase to phase voltages, i.e., Vᵢⱼ(t) defined as follows

Vᵢⱼ(t)=Vᵢ(t)−Vⱼ(t),i,j=a,b,c,i≠j (1)

For brevity, the argument t in Vᵢⱼ(t) and Vᵢ(t) is dropped in the rest of this application. Without loss of generality, let us consider a typical case when V_{ab}≧0, V_{ac}≧0, for which Q₁ is switching in the on/off mode while Q₂ and Q₃ are kept on.

As shown in FIG. 2A, when all switches are on, none of the diodes D₁can conduct. In this case, the inductor current of each phase builds up and the energy captured from the input sources is stored in the magnetic fields of the inductors. We denote this case as mode 1 of operation of the circuit.

Referring to FIG. 2B (mode 2), when Q₁ is turned off, Q₂ is turned off and Q₃ is kept on as long as V_{bc}>0. Similarly, when V_{bc}<0, Q₃ is turned off and Q₂ is kept on. For the case when V_{bc}=0, both Q₂ and Q₃ are kept on.

Next let us consider mode 2 of operation of the circuit as follows. Assuming V_{bc}>0, current flows through diode D₁, load, and back through the anti-parallel diode of Q₂ and Q₃, as depicted in FIG. 2B. In this case, the stored energy in the inductors together with the energy coming from the input sources charge the battery. This condition is continued until i_{Lb} reaches zero, after which mode 3 operation of the circuit starts, as shown in FIG. 2C. In mode 3, the remaining stored energy in Lₐ and L_{c}, along with the energy coming from vₐ and v_{c}, charge the battery until the inductors are totally discharged.

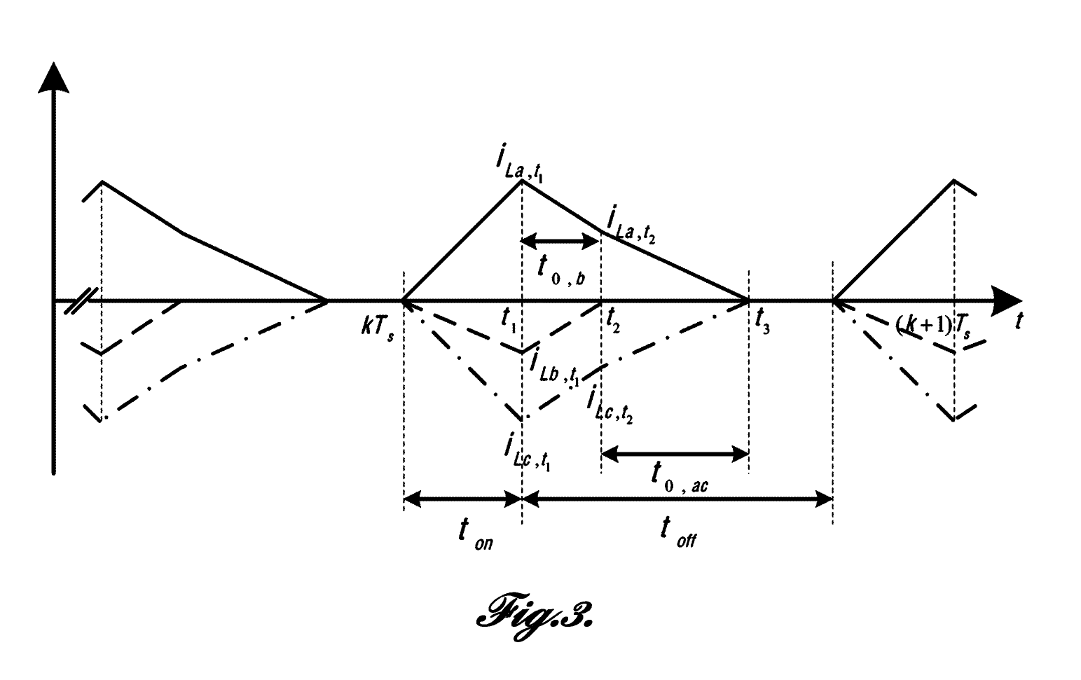

The currents of inductors are shown in FIG. 3 which illustrates the charging and discharging of the inductors in each operating mode. It is worth noting that the converter along with the controller is operated in the discontinuous conduction mode (DCM) as shown in FIG. 3. The operating modes are next analyzed in the following.

Mode 1: Q₁, Q₂, and Q₃ are On, kTₛ≦t≦t₁ (FIG. 3)

In this mode of operation, all MOSFET switches, i.e., Q₁, Q₂ , and Q₃ are on as shown in FIG. 2A. Using Kirchhoff's circuit laws, and performing some algebraic manipulations in each switching interval, we have

$$\frac{d {i}_{La}}{d t} = \frac{1}{3 L} ( {V}_{ab} + {V}_{ac} )$$

$$\frac{d {i}_{Lb}}{d t} = - \frac{1}{3 L} ( 2 {V}_{ab} - {V}_{ac} )$$

$$\frac{d {i}_{Lc}}{d t} = - \frac{1}{3 L} ( 2 {V}_{ac} - {V}_{ab} ) \qquad ( 2 )$$

For simplicity, it is assumed that the values of all the three inductors are equal to L, i.e., Lₐ=L_{b}=L_{b}=L. Thus, the currents in the inductors can be written as follows

$${i}_{La} ( t ) = {i}_{La} ( {kT}_{s} ) + \frac{1}{3 L} {\int }_{{kT}_{s}}^{t} ( {V}_{ab} + {V}_{ac} ) d t$$

$${i}_{Lb} ( t ) = {i}_{Lb} ( {kT}_{s} ) - \frac{1}{3 L} {\int }_{{kT}_{s}}^{t} ( 2 {V}_{ab} - {V}_{ac} ) d t$$

$${i}_{Lc} ( t ) = {i}_{Lc} ( {kT}_{s} ) - \frac{1}{3 L} {\int }_{{kT}_{s}}^{t} ( 2 {V}_{ac} - {V}_{ab} ) d t \qquad ( 3 )$$

where k is the sampling instant and Tₛ is the switching period. In this analysis, the voltage drop across the MOSFETs is ignored when they are on. Since in the discontinuous conduction mode (DCM) the inductors are totally discharged within each switching cycle, the currents of inductors would be zero before or just at the end of each switching cycle, i.e., i_{La}(kTₛ)=i_{Lb}(kTₛ)=i_{Lc}(kTₛ)=0. Moreover, let us assume that, we choose the switching frequency to be much higher than the frequency content of input source. Hence, vᵢⱼ, where i, j=a,b,c, is approximately constant during tₒₙ, i.e., vᵢⱼ(t)=vᵢⱼ(kTₛ). Therefore, during tₒₙ (3) can be approximated as

$${i}_{La} ( t ) = \frac{1}{3 L} ( {V}_{ab , k} + {V}_{ac , k} ) ( t - {kT}_{s} )$$

$${i}_{Lb} ( t ) = - \frac{1}{3 L} ( 2 {V}_{ab , k} - {V}_{ac , k} ) ( t - {kT}_{s} )$$

$${i}_{Lc} ( t ) = - \frac{1}{3 L} ( 2 {V}_{ac , k} - {V}_{ab , k} ) ( t - {kT}_{s} ) \qquad ( 4 )$$

where v_{ij,k} is the value of phase to phase voltage vᵢⱼ at time instant t=kTₛ. Using (4), the currents in the inductors at time instant t=t₁ are given by

$${i}_{La} ( {t}_{1} ) = {i}_{La , {t}_{1}} = \frac{1}{3 L} ( {V}_{ab , k} + {V}_{ac , k} ) ( {t}_{on} )$$

$${i}_{Lb} ( {t}_{1} ) = {i}_{Lb , {t}_{1}} = - \frac{1}{3 L} ( 2 {V}_{ab , k} - {V}_{ac , k} ) ( {t}_{on} )$$

$${i}_{Lc} ( {t}_{1} ) = {i}_{Lc , {t}_{1}} = - \frac{1}{3 L} ( 2 {V}_{ac , k} - {V}_{ab , k} ) ( {t}_{on} ) \qquad ( 5 )$$

Mode 2: Q₁, Q₂, and Q₃ are Turned Off, t₁≦t≦t₂

In this mode of operation, when the switches are turned off the stored energy in the inductors together with the energy coming from the input sources charge the battery as depicted in FIG. 2B. Similar to mode 1, using Kirchhoff's circuit laws and performing some algebraic manipulations in each switching interval, the currents through the inductors can be described by the following equations

$$\frac{d {i}_{La}}{d t} = \frac{1}{3 L} ( {V}_{ab} + {V}_{ac} - 2 {V}_{B} - 2 {V}_{D} )$$

$$\frac{d {i}_{Lb}}{d t} = - \frac{1}{3 L} ( 2 {V}_{ab} - {V}_{ac} - {V}_{B} - {V}_{D} )$$

$$\frac{d {i}_{Lc}}{d t} = - \frac{1}{3 L} ( 2 {V}_{ac} - {V}_{ab} - {V}_{B} - {V}_{D} ) \qquad ( 6 )$$

where V_{B} stands for the battery voltage, and V_{D} represents the voltage drop across diodes D₁. Again, vᵢⱼ(t) is assumed to be approximately constant during t_{off}, i.e., vᵢⱼ(t)=vᵢⱼ(kTₛ), where i,j=a,b,c. Therefore, the currents of the inductors can be approximated as follows

$${i}_{La} ( t ) = {i}_{La , {t}_{1}} + \frac{1}{3 L} ( {V}_{ab , k} + {V}_{ac , k} ) ( t - {t}_{1} ) - \frac{2}{3 L} ( {V}_{B} + {V}_{D} ) ( t - {t}_{1} )$$

$${i}_{Lb} ( t ) = {i}_{Lb , {t}_{1}} - \frac{1}{3 L} ( 2 {V}_{ab , k} - {V}_{ac , k} ) ( t - {t}_{1} ) + \frac{1}{3 L} ( {V}_{B} + {V}_{D} ) ( t - {t}_{1} )$$

$${i}_{Lc} ( t ) = {i}_{Lc , {t}_{1}} - \frac{1}{3 L} ( 2 {V}_{ac , k} - {V}_{ab , k} ) ( t - {t}_{1} ) + \frac{1}{3 L} ( {V}_{B} + {V}_{D} ) ( t - {t}_{1} ) \qquad ( 7 )$$

Substituting (5) into (7) results in

$${i}_{La} ( t ) = \frac{1}{3 L} ( {V}_{ab , k} + {V}_{ac , k} ) ( t - {t}_{1} + {t}_{on} ) - \frac{2}{3 L} ( {V}_{B} + {V}_{D} ) ( t - {t}_{1} )$$

$${i}_{Lb} ( t ) = - \frac{1}{3 L} ( 2 {V}_{ab , k} - {V}_{ac , k} ) ( t - {t}_{1} + {t}_{on} ) + \frac{1}{3 L} ( {V}_{B} + {V}_{D} ) ( t - {t}_{1} )$$

$${i}_{Lc} ( t ) = - \frac{1}{3 L} ( 2 {V}_{ac , k} - {V}_{ab , k} ) ( t - {t}_{1} + {t}_{on} ) + \frac{1}{3 L} ( {V}_{B} + {V}_{D} ) ( t - {t}_{1} ) \qquad ( 8 )$$

Using (8), the currents in the inductors at the time instant t=t₂ are given by

$${i}_{La , {t}_{2}} = \frac{1}{3 L} ( 2 {V}_{ab , k} - {V}_{ac , k} ) ( {t}_{0 , b} + {t}_{on} ) - \frac{2}{3 L} ( {V}_{B} + {V}_{D} ) {t}_{0 , b}$$

$${i}_{Lb , {t}_{2}} = - \frac{1}{3 L} ( 2 {V}_{ab , k} - {V}_{ac , k} ) ( {t}_{0 , b} + {t}_{on} ) + \frac{1}{3 L} ( {V}_{B} + {V}_{D} ) {t}_{0 , b}$$

$${i}_{Lc , {t}_{2}} = - \frac{1}{3 L} ( 2 {V}_{ac , k} - {V}_{ab , k} ) ( {t}_{0 , b} + {t}_{on} ) + \frac{1}{3 L} ( {V}_{B} + {V}_{D} ) {t}_{0 , b} \qquad ( 9 )$$

Referring to FIG. 3, to find t_{0,b}, we set i_{Lb}(t₂)=0. Hence

$${t}_{0 , b} = \frac{2 {V}_{ab , k} - {V}_{ac , k}}{{V}_{B} + {V}_{D} - 2 {V}_{ab , k} + {V}_{ac , k}} {t}_{on} . \qquad ( 10 )$$

Substituting (10) into (9) results in

$${i}_{La , {t}_{2}} = - {i}_{La , {t}_{2}} = \frac{1}{L} \frac{( {V}_{ac , k} - {V}_{ab , k} ) ( {V}_{B} + {V}_{D} )}{{V}_{B} + {V}_{D} - 2 {V}_{ab , k} + {V}_{ac , k}} {t}_{on} . \qquad ( 11 )$$

Mode 3: Q₁, Q₂ , and Q₃ Remain Off, and the Inductor Current of Phase b Reaches Zero (i_{Lb}=0), t₂≦t≦t₃

When i_{Lb} reaches zero, the rest of the stored energy in magnetic fields of Lₐ and L_{c} along with the energy coming from the corresponding input sources charge the battery until they get totally discharged as shown in FIG. 2C. Using a similar analysis for modes 1 and 2 of circuit operation, in each switching interval we have

$$\frac{d {i}_{La}}{d t} = - \frac{d {i}_{Lc}}{d t} = \frac{1}{2 L} ( {V}_{ac , k} - {V}_{B} - {V}_{D} ) \qquad ( 12 )$$

Again, by ignoring the voltage drop across the MOSFETs and assuming that the input voltage vᵢⱼ(t) does not change much during each switching period, the current in the inductors can be obtained as follows

$${i}_{La} ( t ) = {i}_{La , {t}_{2}} + \frac{1}{2 L} ( {V}_{ac , k} - {V}_{B} - {V}_{D} ) ( t - {t}_{2} )$$

$${i}_{Lc} ( t ) = {i}_{Lc , {t}_{2}} + \frac{1}{2 L} ( {V}_{ac , k} - {V}_{B} - {V}_{D} ) ( t - {t}_{2} ) \qquad ( 13 )$$

Referring to FIG. 3, to find t_{0,ac}, lest us set i_{La}(t₃)=i_{La}(t₃)=0 and substitute (11) into (13) which results in

$${t}_{0 , ac} = ( \frac{{V}_{ab , k} - {V}_{ac , k}}{{V}_{ac , k} - {V}_{B} - {V}_{D}} ) ( \frac{2 {t}_{on} ( {V}_{B} + {V}_{D} )}{{V}_{B} + {V}_{D} - 2 {V}_{ab , k} + {V}_{ac , k}} ) \qquad ( 14 )$$

### Averaging Method

Referring to FIG. 3, it can be concluded that

$$Δ {q}_{a} = \frac{1}{2} [ {i}_{La , {t}_{1}} {t}_{on} + ( {i}_{La , {t}_{1}} + {i}_{La , {t}_{2}} ) {t}_{0 , b} + {i}_{La , {t}_{2}} {t}_{0 , ac} ]$$

$$Δ {q}_{b} = \frac{1}{2} [ {i}_{Lb , {t}_{1}} {t}_{on} + {i}_{La , {t}_{1}} {t}_{0 , b} ]$$

$$Δ {q}_{c} = \frac{1}{2} [ {i}_{Lc , {t}_{1}} {t}_{on} + ( {i}_{Lc , {t}_{1}} + {i}_{Lc , {t}_{2}} ) {t}_{0 , b} + {i}_{Lc , {t}_{2}} {t}_{0 , ac} ] \qquad ( 15 )$$

where Δqⱼ is the total charge passing through the inductor of phase j, i.e., Lⱼ, where j=a,b,c, during the time interval kTₛ≦t≦(k+1)Tₛ. By substituting (5), (10), (11), and (14) into (15) and performing some algebraic manipulations, we have

$$\begin{matrix}Δ {q}_{a} = \frac{{t}_{on}^{2}}{6 L} ( \frac{{V}_{B} + {V}_{D}}{{V}_{B} + {V}_{D} - 2 {V}_{ab , k} + {V}_{ac , k}} ) ( {V}_{ab , k} + {V}_{ac , k} ) - \frac{{t}_{on}^{2}}{6 L} ( \frac{{V}_{B} + {V}_{D}}{{V}_{B} + {V}_{D} - 2 {V}_{ab , k} + {V}_{ac , k}} ) {n}_{1} ( {V}_{ij , k} , {V}_{B} , {V}_{D} ) & ( 16 ) \\ Δ {q}_{c} = \frac{{t}_{on}^{2}}{6 L} ( \frac{{V}_{B} + {V}_{D}}{{V}_{B} + {V}_{D} - 2 {V}_{ab , k} + {V}_{ac , k}} ) ( 2 {V}_{ac , k} + {V}_{ab , k} ) + \frac{{t}_{on}^{2}}{6 L} ( \frac{{V}_{B} + {V}_{D}}{{V}_{B} + {V}_{D} - 2 {V}_{ab , k} + {V}_{ac , k}} ) {n}_{1} ( {V}_{ij , k} , {V}_{B} , {V}_{D} ) & ( 17 )\end{matrix}$$

where the nonlinear part, n₁(V_{ij,k},V_{B},V_{D}), is given by

$${n}_{1} ( {V}_{ij , k} , {V}_{B} , {V}_{D} ) = \frac{3 {V}_{ac , k} ( {V}_{ac , k} - {V}_{ab , k} )}{{V}_{ac , k} - {V}_{B} - {V}_{D}} , \\ \begin{matrix}ij = ab , ac , bc \\ and & ( 18 ) \\ Δ {q}_{b} = - \frac{{t}_{on}^{2}}{6 L} [ \frac{{V}_{B} + {V}_{D}}{{V}_{B} + {V}_{D} - 2 {V}_{ab , k} + {V}_{a c , k}} ] ( 2 {V}_{ab , k} - {V}_{ac , k} ) & ( 19 )\end{matrix}$$

It should be noted that all these equations were derived by assuming that i_{Lb}≦i_{Lc} as shown in FIG. 3. Performing a similar analysis as above for the case when i_{Lb}>i_{Lc} we have

$$\begin{matrix}Δ {q}_{a} = \frac{{t}_{on}^{2}}{6 L} ( \frac{{V}_{B} + {V}_{D}}{{V}_{B} + {V}_{D} - 2 {V}_{ac , k} + {V}_{ab , k}} ) ( {V}_{ab , k} + {V}_{ac , k} ) - \frac{{t}_{on}^{2}}{6 L} ( \frac{{V}_{B} + {V}_{D}}{{V}_{B} + {V}_{D} - 2 {V}_{ac , k} + {V}_{ab , k}} ) {n}_{2} ( {V}_{ij , k} , {V}_{B} , {V}_{D} ) & ( 20 ) \\ Δ {q}_{b} = - \frac{{t}_{on}^{2}}{6 L} ( \frac{{V}_{B} + {V}_{D}}{{V}_{B} + {V}_{D} - 2 {V}_{ac , k} + {V}_{ab , k}} ) ( 2 {V}_{ab , k} - {V}_{ac , k} ) + \frac{{t}_{on}^{2}}{6 L} ( \frac{{V}_{B} + {V}_{D}}{{V}_{B} + {V}_{D} - 2 {V}_{ac , k} + {V}_{ab , k}} ) {n}_{2} ( {V}_{ij , k} , {V}_{B} , {V}_{D} ) & ( 21 )\end{matrix}$$

where the nonlinear part, n₂(V_{ij,k},V_{B},V_{D}), is given by

$${n}_{2} ( {V}_{ij , k} , {V}_{B} , {V}_{D} ) = \frac{3 {V}_{ab , k} ( {V}_{ab , k} - {V}_{ac , k} )}{{V}_{ab , k} - {V}_{B} - {V}_{D}} , \\ \begin{matrix}ij = ab , ac , bc \\ and & ( 22 ) \\ Δ {q}_{c} = - \frac{{t}_{on}^{2}}{6 L} [ \frac{{V}_{B} + {V}_{D}}{{V}_{B} + {V}_{D} - 2 {V}_{ac , k} + {V}_{ab , k}} ] ( 2 {V}_{ac , k} - {V}_{ab , k} ) & ( 23 )\end{matrix}$$

The arguments of nᵢ(.), n₂(.) are dropped in the rest of this report for brevity. The average values of the currents in the inductors at instant kTₛ can then be written as

$${i}_{Lj , k} = \frac{Δ {q}_{j}}{{T}_{s}} , j = a , b , c \qquad ( 24 )$$

Substituting (19) and (21) into (24) results in

$$2 {V}_{ab , k} - {V}_{ac , k} = - \frac{6 {LT}_{s}}{{t}_{on}^{2}} ( 1 - \frac{{V}_{in , bc , k}}{{V}_{B} + {V}_{D}} ) {i}_{Lb , k} + {\overline{S}}_{bc} {n}_{2} \\ where \\ {V}_{in , bc , k} = ( 2 - 3 {\overline{S}}_{bc} ) {V}_{ab , k} - ( 1 - 3 {\overline{S}}_{bc} ) {V}_{ac , k} \qquad ( 25 )$$

in which S_{bc} is the control signal which can take values from the discrete set {0,1} as follows

S_{bc}=1, i_{Lb,k}≦i_{Lc,k}

S_{bc}=0, i_{Lb,k}>i_{Lc,k} (26)

The term S̅_{bc} in (26) is the logical complement of S_{bc} (e.g., S_{bc}=0 and S̅_{bc}=1 are equivalent).

Similarly, substituting (17) and (23) into (24), and using the control signal S_{bc}, we have

$$2 {V}_{ac , k} - {V}_{ab , k} = - \frac{6 {LT}_{s}}{{t}_{on}^{2}} ( 1 - \frac{{V}_{i n , bc , k}}{{V}_{B} + {V}_{D}} ) {i}_{Lc , k} + {S}_{bc} {n}_{1} \qquad ( 27 )$$

Solving equations (25) and (27) in terms of V_{ab,k} and V_{ac,k}, results in

$${V}_{ab , k} = - \frac{4 {K}_{bc} {LT}_{s}}{{t}_{on}^{2}} {i}_{Lb , k} - \frac{2 {K}_{bc} {LT}_{s}}{{t}_{on}^{2}} {i}_{Lc , k} + \frac{1}{3} ( {S}_{bc} {n}_{1} + 2 {\overline{S}}_{bc} {n}_{2} )$$

$${V}_{ac , k} = - \frac{2 {K}_{bc} {LT}_{s`}}{{t}_{on}^{2}} {i}_{Lb , k} - \frac{4 {K}_{bc} {LT}_{s}}{{t}_{on}^{2}} {i}_{Lc , k} + \frac{1}{3} ( 2 {S}_{bc} {n}_{1} + {\overline{S}}_{bc} {n}_{2} ) \\ where \\ {K}_{bc} = 1 - \frac{{V}_{i n , bc , k}}{{V}_{B} + {V}_{D}} \qquad ( 28 )$$

which can be further simplified to

$${V}_{bc , k} = \frac{2 {K}_{bc} {LT}_{s}}{{t}_{on}^{2}} {i}_{Lbc , k} + \frac{1}{3} ( {S}_{bc} {n}_{1} - {\overline{S}}_{bc} {n}_{2} ) \\ where {i}_{Lbc , k} = {i}_{Lb , k} - {i}_{Lc , k} . \qquad ( 29 )$$

Equation (29) indicates that there exists a nonlinear resistance at each sampling time t=kTₛ between two phases given by

$${R}_{bc , k} = \frac{2 {LT}_{s}}{{t}_{on}^{2}} ( 1 - \frac{( 2 - 3 {\overline{S}}_{bc} ) {V}_{ab , k} - ( 1 - 3 {\overline{S}}_{bc} ) {V}_{ac , k}}{{V}_{B} + {V}_{D}} ) + {r}_{n , bc} \\ where {R}_{bc , k} = \frac{{V}_{bc , k}}{{i}_{Lbc , k}} and {r}_{n , bc} = \frac{1}{3 {i}_{Lbc , k}} ( {S}_{bc} {n}_{1} - {\overline{S}}_{bc} {n}_{2} ) . \qquad ( 30 )$$

Similarly, R_{ab,k} and R_{ac,k} can be obtained as follows

$$\begin{matrix}{R}_{ab , k} = \frac{2 {LT}_{s}}{{t}_{on}^{2}} ( 1 - \frac{( 2 - 3 {\overline{S}}_{ab} ) {V}_{ca , k} - ( 1 - 3 {\overline{S}}_{ab} ) {V}_{cb , k}}{{V}_{B} + {V}_{D}} ) + {r}_{n , ab} & ( 31 ) \\ {R}_{ac , k} = \frac{2 {LT}_{s}}{{t}_{on}^{2}} ( 1 - \frac{( 2 - 3 {\overline{S}}_{ac} ) {V}_{ba , k} - ( 1 - 3 {\overline{S}}_{ac} ) {V}_{bc , k}}{{V}_{B} + {V}_{D}} ) + {r}_{n , ac} & ( 32 )\end{matrix}$$

where S_{ab} and S_{ac} are defined similar to S_{bc}, i.e.,

S_{ab}=1, i_{La,k}≦i_{Lb,k}

S_{ab}=0, i_{La,k}>i_{Lb,k}

and

S_{ac}=1, i_{La,k}≦i_{Lc,k}

S_{ac}=0, i_{La,k}>i_{Lc,k}

and

$${r}_{n , ab} = \frac{1}{3 {i}_{Lab , k}} ( {S}_{ab} {n}_{1} - {\overline{S}}_{ab} {n}_{2} )$$

$${r}_{n , ac} = \frac{1}{3 {i}_{Lac , k}} ( {S}_{ac} {n}_{1} - {\overline{S}}_{ac} {n}_{2} ) .$$

Similarly, the corresponding terms S̅_{ab} and S̅_{ac} are logical complements of S_{ab} and S_{ac}, respectively. It is worth noting that R_{ac,k}=R_{ca,k}, R_{ab,k}=R_{ba,k}, and R_{bc,k}=R_{cb,k}.

Due to the resistive nature of (30), (31), and (32), if the circuit is operated in the discontinuous conduction mode (DCM), there is no phase difference between the phase-to-phase voltages and corresponding currents. However, it must be noted that phase-to-phase resistance seen from the input for each phase, has a bias term, r_{n,ij}, and the nonlinear term given by (30), (31), and (32), which will be compensated by the feedback controller discussed below.

Next, a condition on the PWM duty cycle is provided to achieve the above resistive relationship. Referring to FIG. 3, the off-time of switches must be large enough to let the inductors to be completely discharged. Thus we have

t_{0,b}+t_{0,ac}≦t_{off}. (33)

tₒₙ and t_{off} can be written in terms of the duty cycle d of PWM waveform as follows

tₒₙ=dT,

t_{off}=(1−d)Tₛ (34)

Substituting (10), (14), and (34) into (33), and performing some algebraic manipulations, the condition to achieve resistive performance can be obtained using the following inequality

$$d \leq 1 - \frac{{V}_{ac , k}}{{V}_{B} + {V}_{D}} . \qquad ( 35 )$$

The above relationship indicates that a pseudo-resistive behavior is achieved at a duty cycle that is dependent on the ratio of the phase to phase input voltage and the sum of the voltage drops across the diode and battery. Similar conditions can be derived for the other switching arrangements.

### Control Strategy

Based on (32), (31), and (30), the parameters that can significantly affect the value of input resistances are Tₛ, tₒₙ, and L. The switching period Tₛ cannot generally be a proper control variable. Thus, tₒₙ has to be used as the control input which can be related to d. To this end, let us define u, a, and y as follows

$$u = \frac{2 {LT}_{s}}{{t}_{on}^{2}} , a = {V}_{B} + {V}_{D} , \\ \begin{matrix}{y}_{pq} = \frac{{V}_{in , pq , k}}{{i}_{Lp , k}} ; p , q = a , b , c ; p \neq q & ( 36 )\end{matrix}$$

where u and a are both positive (u>0, a>0), and

V_{in,pq,k}=(2−3 S̅_{pq})V_{pr,k}−(1−3 S̅_{pq})V_{qr,k}

where r=a,b,c and p≠q≠r. The values of p, q, r are chosen based on the switching arrangements and phase-to-phase voltages as described in (1). By utilizing (36) and the corresponding resistive relationships between phases p and q, i.e., (30), (31), or (32), we have

$${y}_{pq} = u ( 1 - \frac{v}{a} ) + {r}_{n , pq} \\ where v = {V}_{in , pq , k} . \qquad ( 37 )$$

Now, let us define

u=y_{d,pq}+Δu (38)

where y_{d,pq} is the desired input relative resistance of the circuit between phases p and q. Substituting (38) into (37) results in

$${y}_{pq} = ( {y}_{d , pq} + Δ u ) ( 1 - \frac{v}{a} ) + {r}_{n , pq} . \qquad ( 39 )$$

By defining e_{pq}=y_{d,pq}−y_{pq} and using (39), we have

$${e}_{pq} = \frac{v}{a} {y}_{d , pq} - Δ u ( 1 - \frac{v}{a} ) - {r}_{n , pq} . \qquad ( 40 )$$

Now, let us take the control input Δu as follows

$$Δ u = {( 1 - \frac{v}{a} )}^{- 1} ( {w}_{pq} + \frac{v}{a} {y}_{d} - {r}_{n , pq} ) \qquad ( 41 )$$

where w_{pq} is the output of a PI controller given by

w_{pq}=Kₚe_{pq}+K_{I}∫e_{pq}dt. (42)

Substituting (41) into (40) and using (42) results in

(Kₚ+1)e_{pq}+K_{I}∫e_{pq}dt=0 (43)

which indicates that the error would exponentially converge to zero. Therefore, the control law is obtained by substituting (41) into (38) as follows

$$u = {y}_{d , pq} + {( 1 - \frac{v}{a} )}^{- 1} ( {w}_{pq} + \frac{v}{a} {y}_{d , pq} - {r}_{n , pq} ) \qquad ( 44 )$$

which can be further simplified to

$$u = \frac{a}{a - v} ( {y}_{d , pq} + {w}_{pq} - {r}_{n , pq} ) . \qquad ( 45 )$$

In summary, the switching arrangement is first set based on the phase to phase input voltages between at each time instant. The value of the duty cycle, d, is then calculated using (36) and u given by (45) at each time instant.

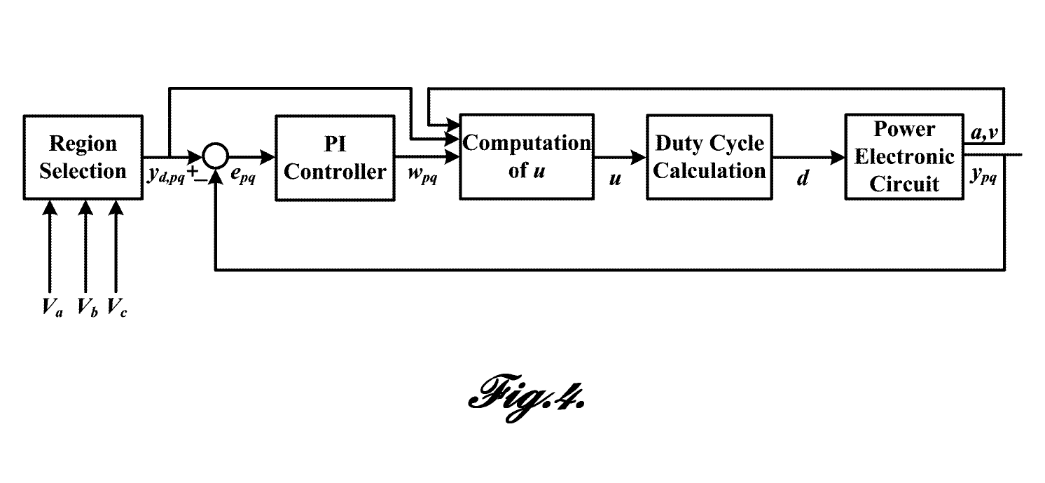

FIG. 4 illustrates the control system block diagram in which the control input is generated by a PWM signal with the duty cycle determined by the controller in accordance with the equations and embodiments provided herein.

It should also be understood that aspects of this disclosure relating to models, controllers or other computing devices for implementing the models, etc., are presented largely in terms of logic and operations that may be performed by conventional electronic components. It will be appreciated by one skilled in the art that the logic described herein may be implemented in a variety of configurations, including software, hardware, or combinations thereof. The hardware may include but is not limited to, analog circuitry, digital circuitry, processing units, application specific integrated circuits (ASICs), and the like or combinations thereof.

As used herein, controllers, control units, control modules, program modules, etc., can contain logic for carrying out general or specific operational features of the present disclosure. The logic can be implemented either in hardware components, which were mentioned earlier, or software components having instructions which can be processed by the processing units, etc. Therefore, as used herein, the term “controller” or “controlling component” can be used to generally describe these aforementioned components, and can be either hardware or software, or combinations thereof, that implement logic for carrying out various aspects of the present disclosure.

In one embodiment, the control system may be implemented within a logic device such as a PLD, an ASIC, a FPGA, and/or the like. In other embodiments, the control system may be implemented within a computing device having at least one processor and a memory containing computer-executable instructions that, if executed by the at least one processor, cause the control system to perform the actions discussed herein; a dedicated digital hardware device implemented, for example, as a state machine configured to perform the actions described; within an application specific processor; and/or within any other suitable computing device.

One embodiment of a control system as described herein is using the same environment that was employed for simulation and verification, MATLAB/SIMPOWER, to develop a real-time implementation of the embedded signal processing system. The system model is converted into a real-time C code and then the generated code is downloaded onto supported DSP board. The model can be also downloaded on FPGA or ASIC target, by generating a bit-true, cycle-accurate HDL code. This description of a control system should be seen as exemplary and not limiting, as a control system may also include a particular computing device specifically programmed with computer-executable instructions that cause the computing device to perform the actions described as taken by the particular engine upon execution.

### Simulation Results

A Simulink model of the converter and its controller were developed using the SIMELECTRONICS toolbox of MATLAB with the following parameters: L=10 mH, C=100 μF, R=1 kΩ, V_{B}=12V, V_{D}=0.6V, Vₐ(t)=sin(2πfᵢt)V,

$${V}_{b} ( t ) = sin ( 2 π {f}_{i} t + \frac{π}{3} ) V , {V}_{c} ( t ) = in ( 2 π {f}_{i} t + \frac{2 π}{3} ) V ,$$

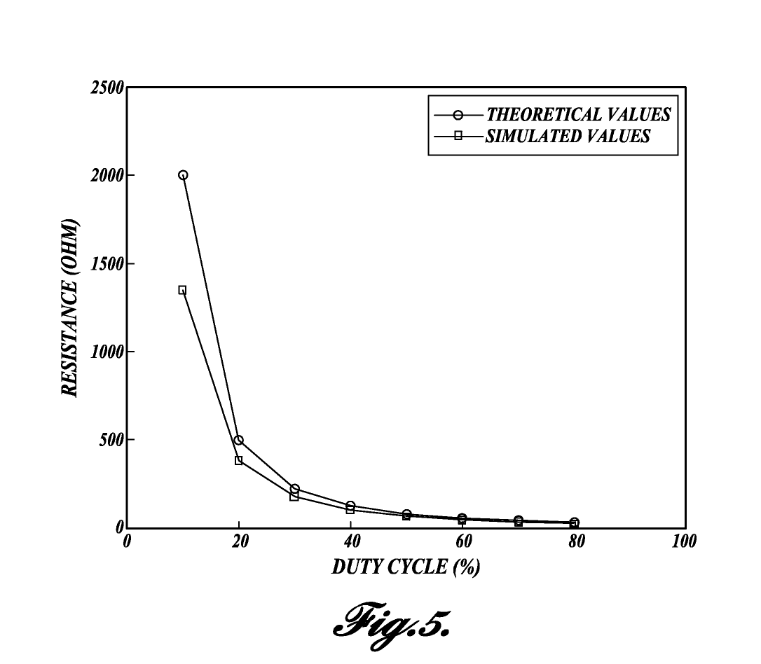

fᵢ=2 Hz, fₛ=1 kHz, and y_{d}=200Ω; where fᵢ and fₛ are input signal and switching frequencies, respectively. FIG. 5 illustrates the variation of input resistances between phases b and c (R_{bc}) versus the PWM duty cycle using simulations and comparing the results with the resistive formula given by (30) when

$$\frac{{V}_{in , bc}}{{V}_{B} + {V}_{D}}$$

is small enough to be ignored. FIG. 5 indicates that the simulated values are close to the corresponding theoretical ones obtained from (30).

The controller is utilized to achieve the desired resistance by changing the duty cycle of PWM signals. Since

$$\frac{a}{a - v}$$

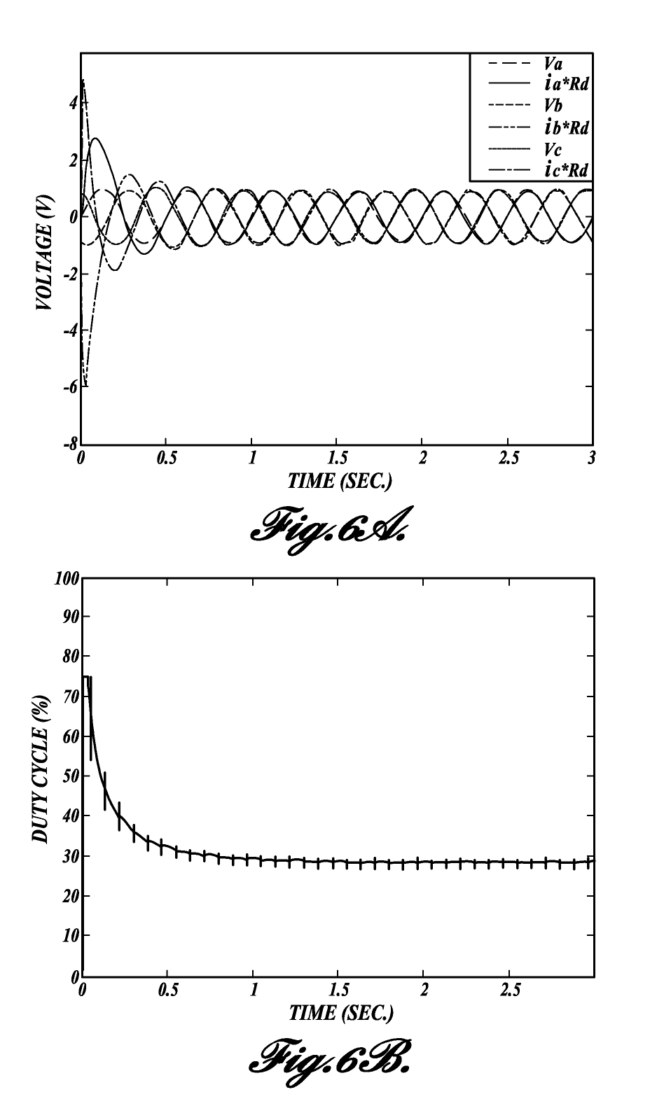

is close to unity, this term is assumed to be one in controller implementation. From FIG. 6A, it is evident that there is no phase difference between input voltage and current of each phase which is achieved by tuning the duty cycle of PWM signal. Considering (30), (31), (32), and ignoring the term

$$\frac{{V}_{in , pq}}{{V}_{B} + {V}_{D}} ,$$

which is typically small for a boost converter, results in Rₖ=200Ω, when the duty cycle of the PWM control signal is almost 30%. FIG. 6B illustrates that the duty cycle is oscillating around this duty cycle. This oscillation is because of the time varying part in the equation of resistances due to the term

$$\frac{{V}_{in , pq , k}}{{V}_{B} + {V}_{D}} .$$

### CONCLUSION

In this disclosure, analytical expressions describing the input characteristic of a three-phase boost-type rectifier were derived, based on which a feedback controller was designed to achieve a desired resistive input behavior. It is shown that the circuit exhibits a nonlinear resistance behavior at the input as long as the duty cycle of the control signal remains below a specific bound. The analytic expressions for this resistive behavior were utilized to derive a feedback control scheme along with the corresponding component values and switching frequencies. Furthermore, performance of the converter with feedback control was demonstrated through simulation studies. The results indicate that one can successfully enforce a linear resistive behavior between each two phases of the input by using the switching regime and control algorithm. The values of phase to phase resistances can be changed by changing the desired set points applied to the controller. The solution enables real-time variation of the generator loading using high efficiency switching power devices. This feature is attractive in several renewable energy conversion systems such as low speed wind, wave energy conversion, and regenerative suspension and braking in electric vehicle applications.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for converting an irregular power signal into an optimal DC power signal comprising the steps of:
(a) providing a three-phase boost converter circuit comprising:
(i) an input;
(ii) an output;
(iii) a pulse-width modulated (PWM) switching circuit in communication with the input and the output; and
(iv) a feedback controller configured to change a resistance of the PWM switching circuit across each phase of the PWM switching circuit in real time;
(b) providing an irregular power signal to the input of the three-phase boost converter circuit; and
(c) adjusting the resistance applied to each phase of the three-phase boost converter circuit using the feedback controller to provide an optimal DC power signal to a load in communication with the output.

2. The method of claim 1, wherein the irregular power signal does not have at least one of the following: a sinusoidal steady state, a fixed amplitude, or a fixed frequency.

3. The method of claim 1, wherein the feedback controller is configured to control an ON/OFF state of individual switches in the PWM switching circuit to achieve a desired resistance in the PWM switching circuit.

4. The method of claim 3, wherein the PWM switching circuit comprises three switches configured to switch between ON and OFF states, and wherein during at least one step of the method a first switch is allowed to switch between ON and OFF states, and a second switch and a third switch are not allowed to switch between ON and OFF states, thereby increasing power efficiency by reducing switching power loss.

5. The method of claim 1, wherein the feedback controller is configured to control a duty cycle of the PWM switching circuit.
